(19) United States
(12) Patent Application Publication
(10) Pub. No.: US 2026/0220501 A1
(43) Pub. Date: Jul. 30, 2026

(54) DETERMINING A COMBINATION OF INFERENCE HYPERPARAMETERS AND PROMPT TEMPLATE FOR INFERENCING

(71) Applicant: International Business Machines Corporation, Armonk, NY (US)

(72) Inventors: Anna Wanda Topol, Clifton Park, NY (US); Dharmashankar Subramanian, Rye Brook, NY (US); Radu Marinescu, Dublin (IE); Long Vu, Chappaqua, NY (US); Elizabeth Daly, Dublin (IE)

(21) Appl. No.: 19/039,933

(22) Filed: Jan. 29, 2025

(51) Int. Cl. G06N 5/04

(52) U.S. Cl. CPC G06N 5/04

(57) ABSTRACT

Embodiments of the disclosure relate to determining the best combination of inference hyperparameters of generative artificial intelligence (AI) and prompt template for inferencing. Aspects include creating prompt templates using natural language questions and sample prompts, the prompt templates comprising prompt sections. Aspects include creating a search space comprising the prompt templates, the prompt sections, and inference hyperparameters of generative AI models, and performing a search including hyperparameter optimization over the search space. A loss metric is determined using the sample prompts and expected outputs for the sample prompts. The search and the hyperparameter optimization determine a selected inference hyperparameters of the generative AI models and a selected prompt template as combination based on the loss metric. Aspects include causing a presentation of the combination of the selected inference hyperparameters and the selected prompt template.

### BACKGROUND

The present disclosure generally relates to computer systems, and more specifically, to computer-implemented methods, computer systems, and computer program products configured and arranged to find/determine the best combination of inference hyperparameters of generative artificial intelligence (AI) and prompt template for inferencing.

Large language models (LLMs) are a type of artificial intelligence algorithm designed to understand and generate human language. They leverage neural network techniques with extensive parameters to process and comprehend text using self-supervised learning techniques. Large language models have revolutionized the field of Natural Language Processing (NLP) by enabling advanced language processing tasks such as text generation, machine translation, summarization, and more.

LLMs operate on the principles of deep learning, utilizing neural network architectures to process and understand human languages. They are trained on vast datasets using self-supervised learning techniques. The core of their functionality lies in the intricate patterns and relationships they learn from diverse language data during training. LLMs consist of multiple layers, including feedforward layers, embedding layers, and attention layers. They employ attention mechanisms, like self-attention, to weigh the importance of different tokens in a sequence, allowing the model to capture dependencies and relationships.

### SUMMARY

Embodiments of the disclosure include a computer-implemented method for finding/determining the best combination of inference hyperparameters of generative artificial intelligence (AI) and prompt template for inferencing. The method includes creating prompt templates using natural language questions and sample prompts, the prompt templates comprising prompt sections. The method includes creating a search space comprising the prompt templates, the prompt sections, and inference hyperparameters of generative artificial intelligence (AI) models. Also, the method includes performing a search including hyperparameter optimization over the search space, where a loss metric is determined using the sample prompts and expected outputs for the sample prompts, where the search and the hyperparameter optimization determine a selected inference hyperparameters of the generative AI models and a selected prompt template as combination based on the loss metric. The method includes causing a presentation of the combination of the selected inference hyperparameters and the selected prompt template

The above features and advantages, and other features and advantages, of the disclosure are readily apparent from the following detailed description when taken in connection with the accompanying drawings.

### BRIEF DESCRIPTION OF THE DRAWINGS

FIG. 1 illustrates a computing environment for executing methods related to determining the best combination of inference hyperparameters of generative artificial intelligence (AI) and prompt template for inferencing in accordance with one or more embodiments.

FIG. 2 illustrates a block diagram of a computer with further details for determining the best combination of inference hyperparameters of generative AI and prompt template for inferencing in accordance with one or more embodiments.

FIGS. 3A and 3B illustrate a flow diagram for determining the best combination of inference hyperparameters of generative AI and prompt template for inferencing in accordance with one or more embodiments.

FIG. 4 illustrates an example prompt template in accordance with one or more embodiments.

FIGS. 5A and 5B illustrate an example prompt template with prompt sections of path 1 of FIG. 4 in accordance with one or more embodiments.

FIG. 6 illustrates an example prompt template with prompt sections of path 2 of FIG. 4 in accordance with one or more embodiments.

FIG. 7 illustrates an example prototyping prompt template for a text to SQL task in accordance with one or more embodiments.

FIG. 8 illustrates an example of the constraint (relation) between the schema linking section and the content linking section of the prompt template in accordance with one or more embodiments.

FIG. 9 illustrates an example of mapping the inference hyperparameters in a search space in accordance with one or more embodiments.

FIG. 10 illustrates an example of handling constraints with search and hyperparameter optimization in accordance with one or more embodiments.

FIG. 11 illustrates a flowchart of a computer-implemented method for finding/determining the best combination of inference hyperparameters of generative AI models and prompt template for inferencing in accordance with one or more embodiments.

The above features and advantages, and other features and advantages, of the disclosure are readily apparent from the following detailed description when taken in connection with the accompanying drawings.

### DETAILED DESCRIPTION

One or more embodiments are configured and arranged for finding/determining the best combination of inference hyperparameters of generative artificial intelligence (AI) and prompt template for inferencing. One or more embodiments cause the combination of the determined inference hyperparameters of the generative AI and the determined prompt template to be utilized to execute a user prompt on a computer system.

There are two approaches in existing systems for finding the best machine learning (ML)/artificial intelligence (AI) models, which require training and evaluating the models. One existing approach is to train and evaluate machine learning models on-the-fly and find the best model; this is expensive, because training and evaluation is performed at test time (e.g., taking hours or days). Also, this existing approach is an expensive technique for fine-tuning (e.g., train and evaluate) LLMs. Another existing approach is meta-learning, where a meta learner is trained offline, and inference time is very short (e.g., taking seconds). However, it is very expensive to create a medium-size training set for the meta learner.

Generative AI incorporates LLMs. In the context of generative AI, fine-tuning the LLM is expensive. As discussed in one or more embodiments, performance of LLM depends highly on prompt templates and its inference hyperparameters. One or more embodiments are configured to find the best combination of a prompt template and values of inference hyperparameters of the LLM using search and hyperparameter optimization. In generative AI, the inference hyperparameters are different from the training parameters.

Inference hyperparameters are used during the inference phase, which is the stage where the trained AI model is used to generate outputs or make predictions based on new input data. These inference hyperparameters control how the machine learning model behaves when it is generating text, making predictions, or performing other tasks. Some example inference hyperparameters may include:
1) Temperature: the value used to modulate the next token probabilities. Temperature controls the randomness of predictions by scaling the logits before applying the softmax function.
2) Top-k sampling: limits the sampling pool to the top k most probable tokens. This helps in reducing the likelihood of selecting low-probability tokens, leading to more coherent and relevant outputs.
3) Top-p (nucleus) sampling: limits the sampling pool to the smallest set of tokens whose cumulative probability exceeds a threshold p. This provides a balance between diversity and coherence by dynamically adjusting the sampling pool based on the cumulative probability. If set to float <1, only the smallest set of most probable tokens with probabilities that add up to top_p or higher are kept for generation.
4) Max tokens: specifies the maximum number of tokens to generate in the output. This controls the length of the generated text, ensuring it does not exceed a certain limit.
5) Repetition penalty: the parameter for repetition penalty, which penalizes the model for generating repetitive sequences. This helps in producing more varied and interesting outputs by discouraging the repetition of the same tokens or phrases.
6) Beam search width: this determines the number of beams (parallel sequences) to explore during beam search.
7) Do_sampling: this tells whether or not to use sampling, otherwise, use greedy decoding.
8) Min_p: minimum token probability, which will be scaled by the probability of the most likely token.
9) Typical_p: local typicality measures how similar the conditional probability of predicting a target token next.

On the other hand, training hyperparameters are used during the training phase, which is the stage where the machine learning model learns from the training data. These training hyperparameters control various aspects of the training process, such as the learning rate, batch size, number of epochs, optimizer, dropout rate, weight decoy, activation functions, and model architecture.

AI engines may use generative artificial intelligence which is a type of AI that can create new content and ideas, including conversations, stories, images, videos, and music. AI technologies attempt to mimic human intelligence in nontraditional computing tasks like image recognition, natural language processing (NLP), and translation. AI engines are trained to learn human language, programming languages, art, chemistry, biology, or any complex subject matter. AI engines reuse training data to solve new problems. An organization can use AI engines for various purposes. Like any artificial intelligence, an AI engine works by using machine learning models such as very large models that are pretrained on vast amounts of data. Examples of very large models can include foundation models and large language models.

Foundation models: Foundation models (FMs) are machine learning models trained on a broad spectrum of generalized and unlabeled data. Foundation models are capable of performing a wide variety of general tasks. Foundation models are the result of the latest advancements in a technology that has been evolving for decades. In general, a foundational model uses learned patterns and relationships to predict the next item in a sequence. For example, with image generation, the foundational model analyzes the image and creates a sharper, more clearly defined version of the image. Similarly, with text, the foundational model predicts the next word in a string of text based on the previous words and their context. The foundational model then selects the next word using probability distribution techniques.

Large language models: Large language models (LLMs) are one class of foundational models. LLMs are specifically focused on language-based tasks such as such as summarization, text generation, classification, open-ended conversation, and information extraction.

The architecture of LLMs is determined by several factors, such as the objective of the specific model design, available computational resources, and the type of language processing tasks to be carried out. The general architecture includes components like input embeddings, positional encoding, encoder layers, self-attention mechanisms, feed-forward neural networks, decoder layers, multi-head attention, layer normalization, and output layers. Transformer-based models, such as GPT and BERT, follow this architecture and have become the standard for NLP tasks.

LLMs have a wide range of applications across various domains: Text Generation: LLMs can generate human-like text for various purposes, including content creation, creative writing, and storytelling. Language Translation: They can aid in translating text between different languages with improved accuracy and fluency. Text Summarization: LLMs can generate concise summaries of longer texts or articles. Sentiment Analysis: They can analyze and understand sentiments expressed in social media posts, reviews, and comments. Code Generation: LLMs can assist developers in building applications, finding errors in code, and uncovering security issues in multiple programming languages.

Descriptions of various embodiments of the present disclosure are presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

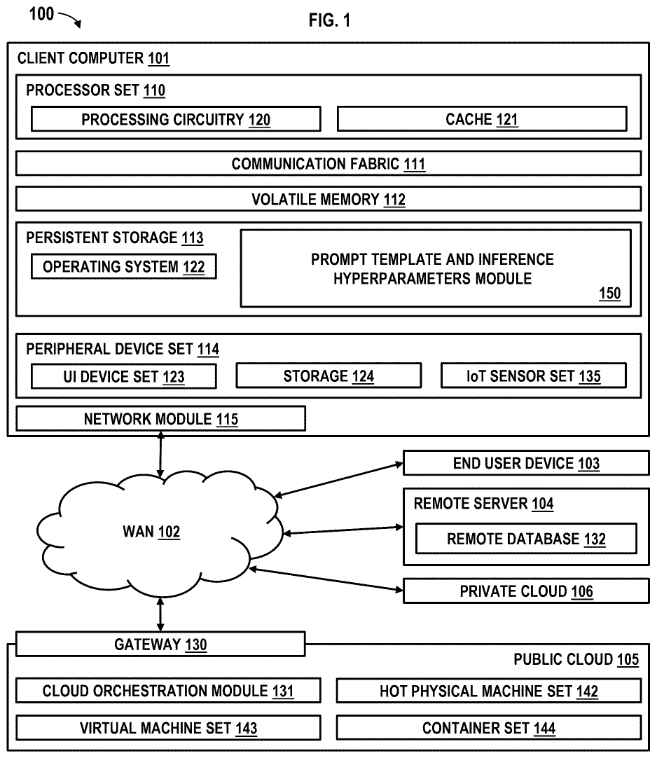

FIG. 1 illustrates a computing environment 100, according to an embodiment. Computing environment 100 contains an example of an environment for the execution of at least some of the computer code involved in performing the inventive methods, such as a prompt template and inference hyperparameters module 150 for determining the best combinations of prompt templates and inferencing parameters of LLM. In addition to the prompt template and inference hyperparameters module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and prompt template and inference hyperparameters module 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in prompt template and inference hyperparameters module 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the prompt template and inference hyperparameters module 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the oner of the entity is also updated).

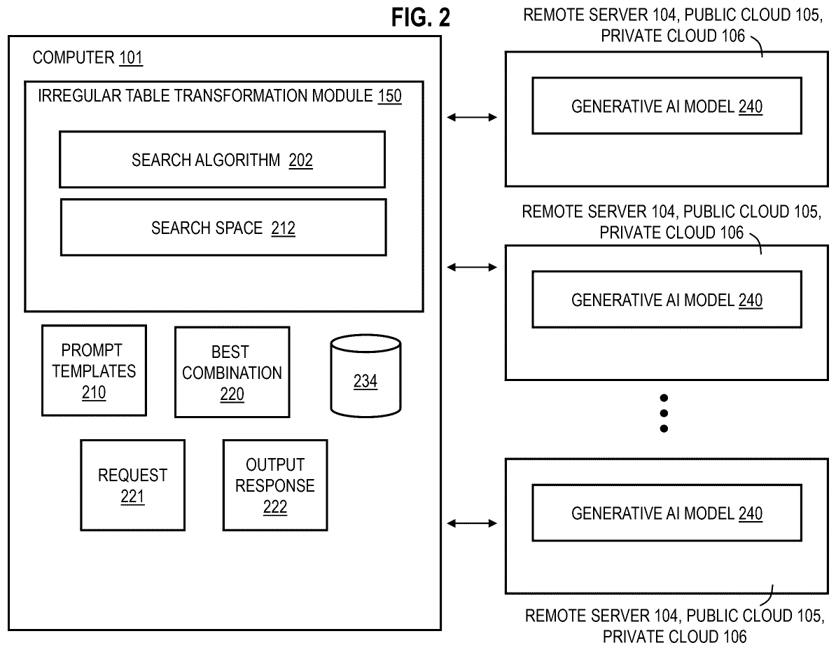

FIG. 2 depicts a block diagram of the computer 101 with further details for finding/determining the best combination of values for the inference hyperparameters of generative artificial intelligence (AI) and prompt template for inferencing, displaying the best combination of the inference hyperparameters of generative AI and prompt template, causing a user prompt to be entered in the determined prompt template for use with determined inference hyperparameters, and causing execution of the generative AI with the (determined) combination of the prompt template and inference hyperparameters of generative AI such that the output of the generative AI is provided to a user in accordance with one or more embodiments. The prompt template and inference hyperparameters module 150 may include, call, employ, and/or be coupled to a search algorithm 202, a search space 212, etc. The prompt template and inference hyperparameters module may include, call, employ, and/or be coupled to various application programming interfaces (APIs) to operate according to one or more embodiments.

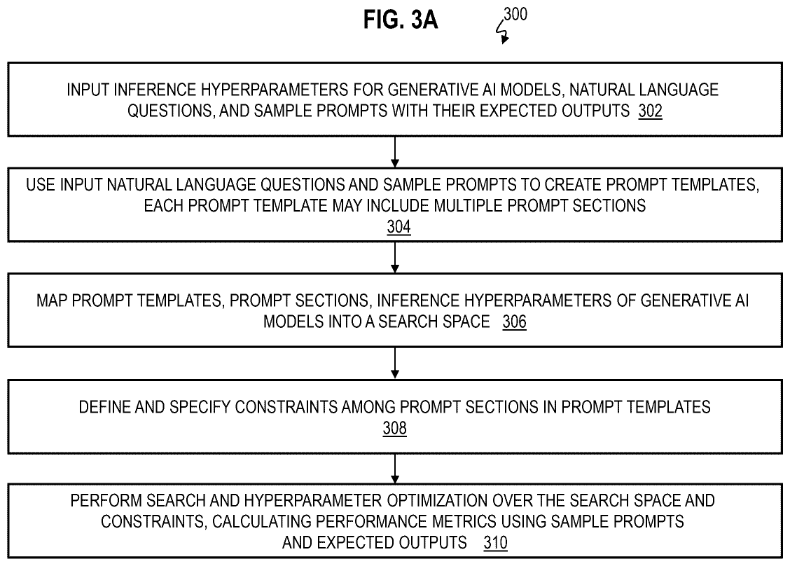

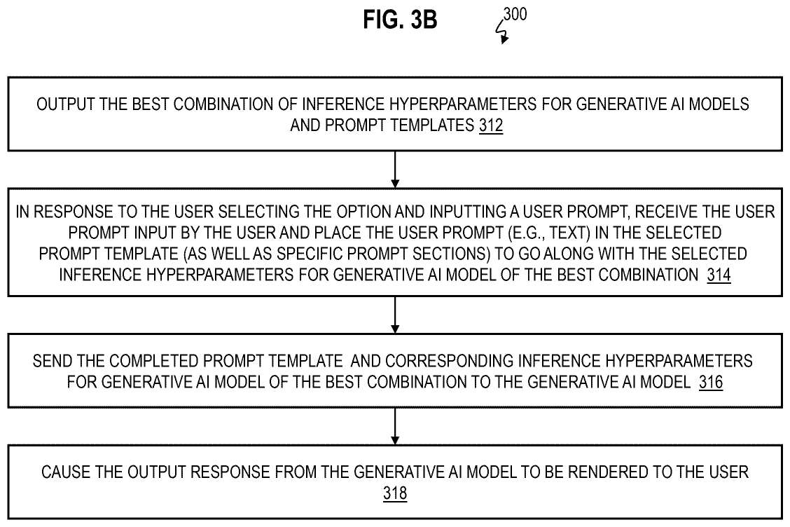

FIGS. 3A and 3B depict a flow diagram of a computer-implemented method 300 for finding/determining the best combination of values for inference hyperparameters of generative AI and prompt template for inferencing, displaying the best combination of the inference hyperparameters of generative AI and prompt template, causing a user prompt to be entered in the determined prompt template for use with determined inference hyperparameters, and causing execution of the generative AI with the (determined) combination of the prompt template and inference hyperparameters of generative AI such that the output of the generative AI is provided to a user in accordance with one or more embodiments. In one or more embodiments, the computer-implemented method 300 can be performed at least in part by the prompt template and inference hyperparameters module 150 of the computer 101 in the computing environment 100 shown in FIG. 1.

At block 302 of the computer-implemented method 300, the prompt template and inference hyperparameters module 150 is configured to receive the input of inference hyperparameters for generative AI models, natural language questions (NLQs), and a small set of sample prompts and (their) expected outputs.

The inference hyperparameters for generative AI models can be retrieved from a repository 234. The different or possible values of the inference hyperparameters for generative AI models can be in the repository 234. Once selected as determined herein, the selected values of the inference hyperparameters can be applied to any of the generative AI models 240.

At block 304, the prompt template and inference hyperparameters module 150 is configured to use input natural language questions and sample prompts to create prompt templates 210, where each prompt template may include multiple prompt sections.

At block 306, the prompt template and inference hyperparameters module 150 is configured to map the prompt templates 210, the prompt sections of the prompt templates 210, the inference hyperparameters of the generative AI models into search space 212. For instance, for inference hyperparameters like “temperature”, which is a float variable, the present disclosure can discretize it into to a list of values. These values are then considered as search choices during the search process.

In one or more embodiments, some of the inference hyperparameters of the generative AI models may have a single dimension in the search space 212. In one or more embodiments, some of the inference hyperparameters of the generative AI models may have multiple dimensions (e.g., more than one dimension) in the search space 212. An inference hyperparameter may have multiple values that could be chosen for a particular inference hyperparameter, and the prompt template and inference hyperparameters module 150 choose an appropriate value as discussed herein. Additionally, some hyperparameters like “top_k”, “decoding_method”, etc., together with “temperature” create a multi-dimensional search space, in which “temperature”, “decoding_method”, etc., are dimensions. Accordingly, each dimension has multiple values (or choices), and the search space 212 has multiple dimensions.

The search space 212 is a discreate search space that can be exploited by a searcher such as a search algorithm 202. In one or more embodiments, the search space 212 can have coordinate axes in a coordinate system. In one or more embodiments, the search space 212 can be representative of data in a database having the prompt templates 210, the prompt sections of the prompt templates 210, and the inference hyperparameters of the generative AI models.

At block 308, the prompt template and inference hyperparameters module 150 is configured to define and specify constraints for the prompt sections in the prompt templates 210. Constraints for the prompt sections in the prompt templates are rules or conditions that define how different prompt sections of a prompt template can be combined and/or used together. In one or more embodiments, the constraints can include a particular sequence for the prompt sections. These constraints ensure that the generated prompts are coherent, meaningful, and effective for the intended task.

At block 310, the prompt template and inference hyperparameters module 150 is configured to perform search and hyperparameter optimization (HPO) over the search space 212 and constraints, while calculating performance metrics using sample prompts and expected outputs. In one or more embodiments, any suitable search and hyperparameter optimization techniques can be utilized over the search domain of the search space 212.

In one or more embodiments, a nested bilevel tuning system can be utilized to perform search and hyperparameter optimization over the search space 212 and constraints, where the outer level searches across generative AI models (e.g., LLMs), while the inner level searches for the optimized values of inference hyperparameters and prompt templates and components/sections for one generative AI model (e.g., LLM). The performance metric on a validation set obtained by the generative AI model (e.g., LLM) can be used to guide the search for optimized configurations. An example of the search algorithm 202 that can be used in the Limited Discrepancy Search. Other examples of the search algorithm 202 may include Bayesian Optimization, random search, and grid search.

At block 312, based on the search and hyperparameter optimization over the search space 212 and constraints, the prompt template and inference hyperparameters module 150 is configured to output the best combination 220 of values for the inference hyperparameters of generative AI models and prompt template 210 with specific prompt sections. In one or more embodiments, the selected prompt template and selected inference hyperparameters module 150 can cause the best combination 220 of values of inference hyperparameters for generative AI models and prompt template 210 with specific prompt sections to be displayed on a display screen for selection as an option by a user.

At block 314, in response to the user selecting the option and inputting a user prompt, the prompt template and inference hyperparameters module 150 is configured to receive the user prompt input by the user and place the user prompt (e.g., text) in the selected prompt template 210 (as well as specific prompt sections) to go along with the selected values of inference hyperparameters for generative AI model of the best combination 220, all of which is a request 221 that is to be sent to generative AI model 240 on one or more computer systems.

At block 316, the prompt template and inference hyperparameters module 150 is configured to send the completed prompt template 210 (e.g., filled in prompt template) and corresponding values of inference hyperparameters for generative AI model of the best combination 220 to the generative AI model 240 as the request 221. In response to the request 221, this causes the generative AI model 240 to process the completed prompt template 210 in accordance with corresponding values of inference hyperparameters of the best combination 220 and generate an output response 222.

At block 318, the prompt template and inference hyperparameters module 150 can cause the output response 222 from the generative AI model 240 to be rendered to the user. In one or more embodiments, the output response 222 can be displayed on a display screen, presented as audio on speakers, presented as video, etc. In one or more embodiments, the prompt template and inference hyperparameters module 150 can cause the output response 222 to be visually and/or audibly presented on one or more of the IoTs, the UI device set 123, etc.

As technical effects and solutions, one or more embodiments improve the functioning of a computer system by reducing the number of computer resources needed to process multiple errant requests that do not return the desired output to the user by determining a combination of selected values for inference hyperparameters along with the selected prompt template to be the combination request for the generative AI model. The combination request avoids further training of the AI generative model (e.g., LLM) which requires large dataset, excessive time, and lots of computer resources, avoids repeatedly sending different requests to the AI generative model (e.g., LLM) (because the output is not what is desired) which continuously uses computer resources to process the requests, avoids excessive input/output bandwidth associated with sending repeated requests, etc. Furthermore, technical effects and solutions use the selected values of the inference hyperparameters to change the generative AI model at runtime to function more efficiently with the selected prompt template, in order to generate the desired output response, thereby resulting in improvements to the computer system (executing the generative AI model) itself. As a result of not requiring multiple requests and/or avoiding additional training of the AI model, the improvements (e.g., reducing the use of computer resources) include reduced memory usage, reduced/decreased CPU usage, reduced/decreased I/O functionality, reduced/decreased network bandwidth, etc.

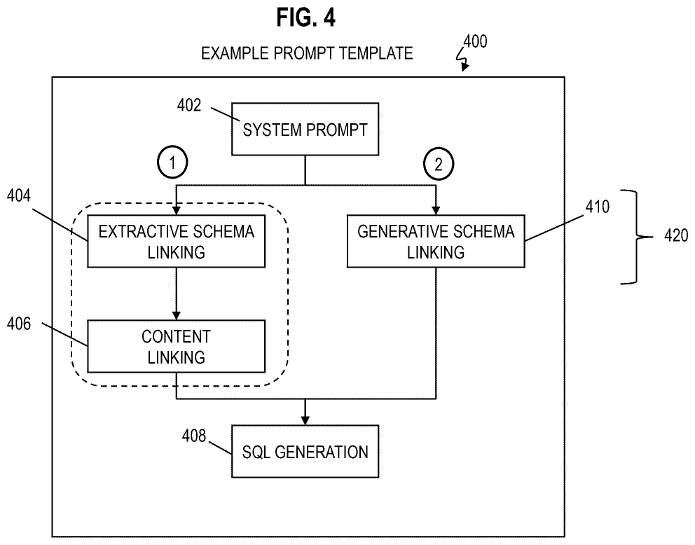

FIG. 4 depicts an example prompt template 400 in accordance with one or more embodiments. The example prompt template 400 can be one of the prompt templates 210. In this example, a user wishes to send to the generative AI model 240 a request to convert text to a structured query language (SQL), and the prompt template and inference hyperparameters module 150 is configured to provide the best combination 220 to accomplish this task.

In FIG. 4, the prompt template 400 can be representative of a text to SQL prompt template, with prompt sections and constraints. In this example, the text to SQL prompt template has four prompt sections. The four example prompt sections can include a system prompt section 402, a schema linking section 420, a content linking section 406, and an SQL generation section 408. The schema linking section 420 has two options, which are extractive schema linking section 404 and generative schema linking section 410.

Constraints can relate to the order in which prompt sections are performed in the prompt template. Under section constraints, the system prompt section 402 is optional, and the extractive schema linking section 404 and the content linking section 406 are to be joined together and are optional. Under the section constraints, the generative schema linking section 410 has an empty content linking section (e.g., there is no content linking section required for generative schema linking section) and is optional. The SQL generation section 408 is required under the section constraints.

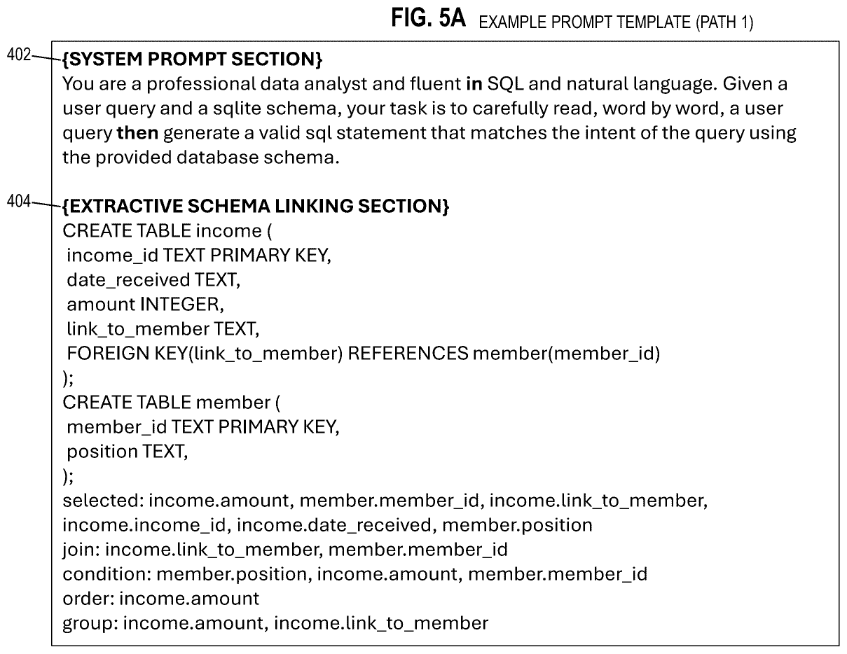

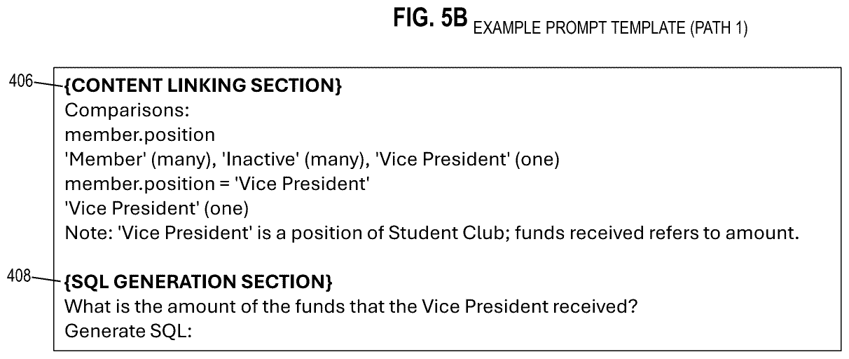

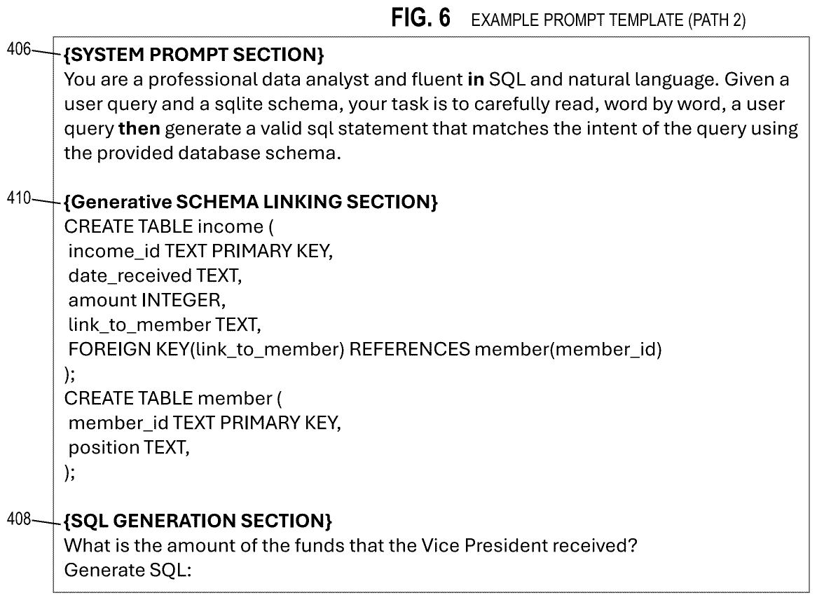

As can be seen in FIG. 4, the prompt template 400 as a text to SQL prompt template has two paths indicated as path 1 and path 2. Path 1 includes the system prompt section 402, the extractive schema linking section 404, the content linking section 406, and the SQL generation section 408. Path 2 includes the system prompt section 402, the generative schema linking section 410, and the SQL generation section 408. To further illustrate the prompt template 400 as a text to SQL prompt template with path 1 and path 2 respectively, an example text to SQL prompt template for extractive schema linking is depicted in FIGS. 5A and 5B, and an example text to SQL prompt template for generative schema liking is depicted in FIG. 6.

In FIGS. 5A and 5B, the text of the user prompt is to be provided in the text to SQL prompt template for path 1. FIGS. 5A and 5B together include the system prompt section 402, the extractive schema linking section 404, the content linking section 406, and the SQL generation section 408, which are to be input to the generative AI model 240 with the selected values of inference hyperparameters (e.g., the best combination 220) to cause the generative AI model 240 to generate the output response 222.

In FIG. 6, the text of the user prompt is to be provided in the text to SQL prompt template for path 2. FIG. 6 includes the system prompt section 402, the generative schema linking section 410, and the SQL generation section 408, which are to be input to the generative AI model 240 with the selected values of inference hyperparameters (e.g., the best combination 220) to cause the generative AI model 240 to generate the output response 222.

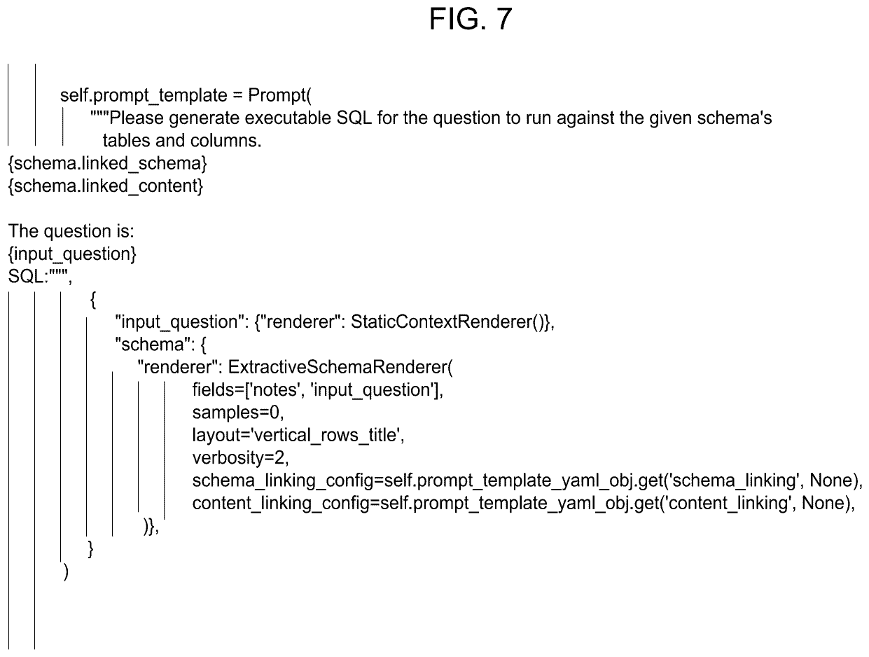

FIG. 7 depicts prototyping prompt template for text to SQL task according to one or more embodiments. FIG. 7 is an example illustration of a Python code snippet that shows how a prompt string for the SQL Generation model is created by using different sub sections like Schema Linking and Content Linking.

Further details of an example are discussed for mapping prompt templates and prompt sections into a search space (e.g., the search space 212). A prompt template P consists of n sections {S₁,Sₛ, . . . , Sₙ}, and for each section Sᵢ there are k possible options (values) {sᵢ₁, sᵢ₂, . . . , sᵢₖ}. In addition, the present disclosure may have additional constraints among options allowed for different sections. A constraint may involve one or more sections of the prompt template:
1) For example, a constraint between sections 2 and 3 allows the following
options only: R₂₃(S₂,S₃):{(s₂₄,s₃₁), (s₂₁,s₃₃)} and all the other combinations are forbidden. A constraint is defined over a set of variables (in this example, the variables are S₂ and S₃ corresponding to sections 2 and 3 of the prompt template) and lists the allowed combinations of values assigned to the variables. In this example, it is assumed that each variable has 4 values in its domain, for example, S₂ can take values s₂₁, s₂₂, s₂₃ and s₂₄. Therefore, the constraint in the example only allows the combinations of values: s₂₄ and s₃₁, and respectively s₂₁ and s₃₃ for variables S₂ and S₃. As a note, the values s₂₁, s₂₂, . . . could be considered as different versions of the prompt section S₂.
2) In the text-to-SQL example, if the prompt template and inference hyperparameters module 150 selects a generative schema linking for the schema linking section 420 then there must be an empty content linking section (e.g., no content linking section is depicted in path 2 in FIG. 4).

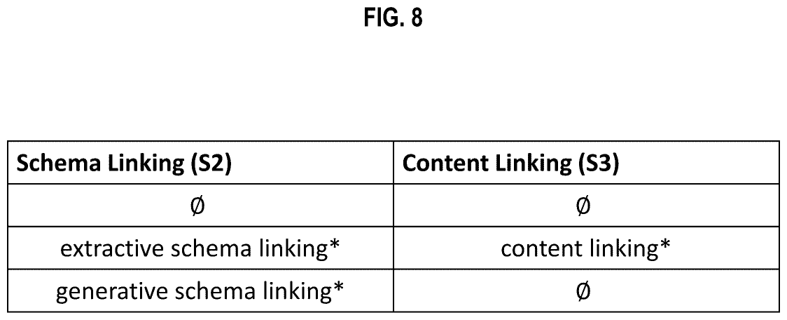

FIG. 8 depicts an example of the constraint (relation) between the schema lining and content linking sections of the prompt template. As one option, there can be no schema linking (S2) and no content linking (S3). As another option, there can be extractive schema linking (S2) and content schema linking (S3), which are required to be joined together (e.g., in path 1 in FIG. 4).

Further details of constrains are discussed. The constraints between different prompt sections of the prompt template are represented explicitly as relations (e.g., sets of allowed options/values for the prompt sections involved): for example, a constraint between sections 2 and 3 allows the following options only:
R₂₃(S₂,S₃):{(s₂₄,s₃₁), (s₂₁,s₃₃)} and all the other combinations are forbidden.

The present disclosure also allows implicit representations of constraints (instead of listing all combinations of allowed options): for example, all different (S1, S2, S3), which means the allowed options for three sections (S1, S2, S3) must be different.

Additionally, the constraints can be propagated during search (e.g., forward checking) to prune values/options of prompt sections.

Further details are discussed of an example regarding hyperparameter optimization. The following is an example for computing the loss for hyperparameter optimization:
1) Use the input sample prompts and expected outputs to define a validation dataset V containing pairs (input, R) where, e.g., R, the response, is a known SQL query, a text summary, etc.
2) Given the current configuration C in the search space, for each pair (input, R) in the validation set, use C to create the appropriate prompt template for input and use it to generate a new response R′.
3) Compute the loss between R and R′ (e.g., using rouge score, Bert score, etc.), and finally average over all examples in the validation set V. This is the objective function that is optimized/minimized during search. For example, the prompt template that is selected has the smallest loss metric. As noted above, the validation set has N elements, each element has a pair of sample prompt and expected output. For one sample prompt, the search algorithm 202 (or model) generates an output. The search algorithm 202 computes the loss between the generated output (e.g., R′) and the expected output (e.g., R) for this sample. Then, the search algorithm 202 averages the loss across N samples in the validation set (e.g., V), and the search algorithm 202 uses this average loss to make progress during the search, for example, finding a better point in the search space 212. The search algorithm 202 stops when the search time budget runs out or when the search algorithm exhausts the search space 212 (e.g., it checks all possible points on the search space). During the search, the best search point with the least loss is tracked, so at the end of the search, this point is returned. That is the solution. It is noted that a search point in the in the search space in the multi-dimensional point.

The loss metric/function can be ROUGE-L score, Bert-score, cosine similarity, etc. The loss metric/function can be tree-based edit distance for SQL query comparison, edit distance, n-gram matching, etc. Any suitable loss metric/function can be any suitable loss function. A loss function, also known as a cost function or objective function, is a mathematical function used in machine learning and optimization to quantify the difference between the predicted output of a model and the actual target value.

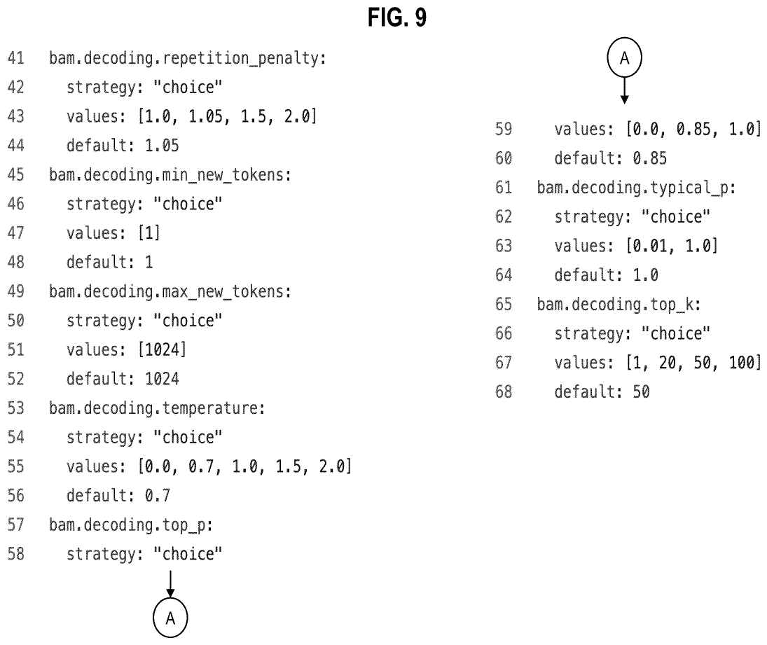

FIG. 9 depicts an example of mapping the inference hyperparameters in a search space according to one or more embodiments. The values of the inference hyperparameters ranges are defined. Also, a default range is provided. The search and hyperparameter optimization are performed from the different values of the inference hyperparameters in order to find the best combination of the values for the inference hyperparameters and prompt template.

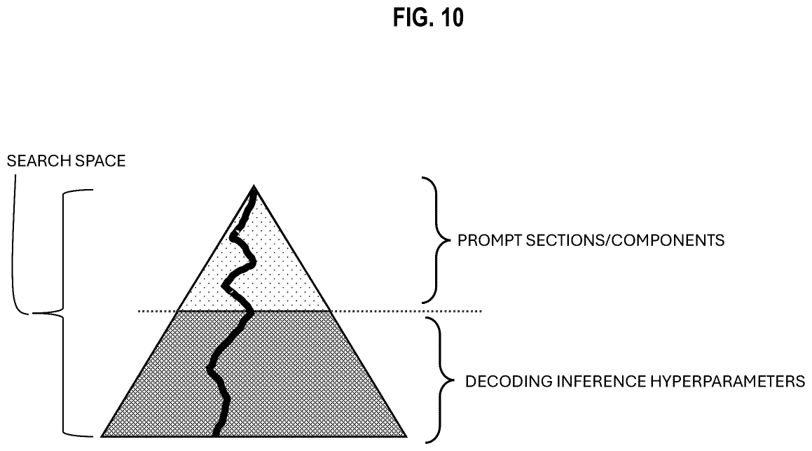

FIG. 10 depicts an example of handling constraints with search and hyperparameter optimization according to one or more embodiments. FIG. 10 illustrates a search space (e.g., search space 212). The prompt template sections with corresponding options, the constraints between the different sections, and the values of inference hyperparameters associated with the decoding define a search space. The search algorithm 202 is configured to traverse the search space using Limited Discrepancy Search (LDS) with constraint propagation (e.g., forward checking). At each node expansion, the search algorithm 202 is configured to check if all constraints and satisfied and perform 1 step lookahead by pruning the domains of the prompt section variables. During the search, the constraints are used to prune the search space and thus make the search more effective. Specifically, the search assigns values to the variables, one at a time. When assigning a value to a variable, the constraints that mention that variable together with the variables already assigned along the current path in the search tree are checked to make sure that the value assignments are allowed. If all relevant constraints are satisfied, then the search proceeds to the next unassigned variable. Otherwise, the search either tries a new value for the current variable or backtracks to the previous variable and recursively tries a new value. This way, all the leaf nodes in the search tree will correspond to value assignments to all variables that satisfy the constraints.

Limited Discrepancy Search (LDS) is a search algorithm designed to efficiently explore the search space of possible solutions by focusing on solutions that are close to a heuristic or initial guess. It systematically limits the number of deviations (discrepancies) from the heuristic's recommendations, making it particularly useful for large search spaces where exhaustive search would be computationally prohibitive. An example of Limited Discrepancy Search (LDS) may include any of the following.

1) Initialization: Heuristic: Start with a heuristic that provides an initial guess or recommendation for the best path or solution. This heuristic is based on domain knowledge or previous experience. Discrepancy Limit: Set an initial discrepancy limit, starting with zero discrepancies.
2) Zero Discrepancies: Follow Heuristic: Begin by following the heuristic exactly, making decisions that align perfectly with the heuristic's recommendations. This means exploring the path with zero discrepancies.
3) Increasing Discrepancies: Increment Discrepancy Limit: If no solution is found with zero discrepancies, increment the discrepancy limit by one. Explore with One Discrepancy: Allow for one discrepancy, meaning one decision can deviate from the heuristic's recommendation. Explore all possible solutions with exactly one discrepancy. Further Increments: Continue incrementing the discrepancy limit and exploring solutions with the allowed number of discrepancies (two, three, etc.).
4) Systematic Exploration: Prioritize Fewer Discrepancies: The algorithm prioritizes solutions with fewer discrepancies, as they are more likely to be close to the optimal solution. Breadth-First Search: Within each discrepancy level, the algorithm performs a breadth-first search to explore all possible solutions with the allowed number of discrepancies.
5) Evaluation: Check Solutions: Evaluate each solution based on a predefined objective function or performance metric. Terminate on Success: If a satisfactory solution is found, the search terminates. If the maximum allowed number of discrepancies is reached without finding a solution, the search also terminates.

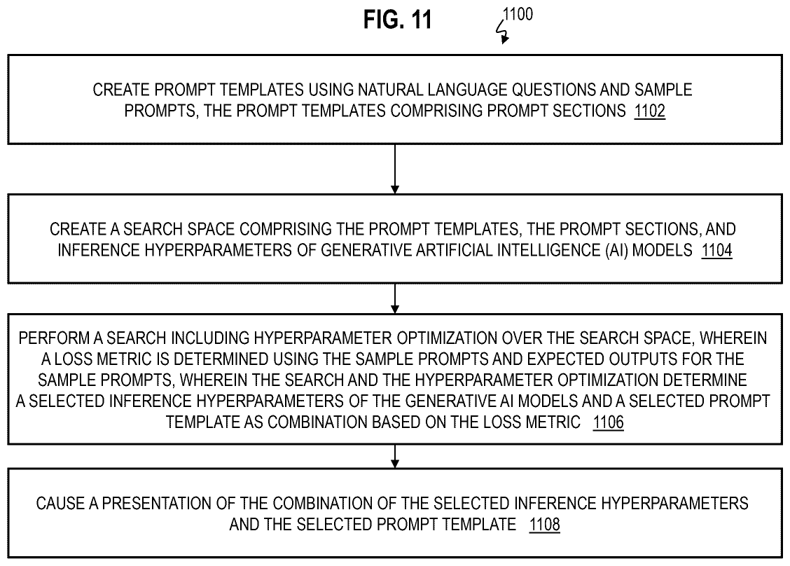

FIG. 11 depicts a flowchart of a computer-implemented method 1100 for finding/determining the best combination of inference hyperparameters of generative AI models and prompt template for inferencing, displaying the best combination of the inference hyperparameters of generative AI and prompt template, causing a user prompt to be entered in the determined prompt template for use with determined inference hyperparameters, and causing execution of the generative AI with the (determined) combination of the prompt template and inference hyperparameters of generative AI such that the output of the generative AI is provided to a user in accordance with one or more embodiments. Reference can be made to any figures discussed herein.

At block 1102, the prompt template and inference hyperparameters module 150 is configured to create prompt templates 210 using natural language questions and sample prompts, the prompt templates 210 having prompt sections. At block 1104, the prompt template and inference hyperparameters module 150 is configured to create a search space (e.g., search space 212) having the prompt templates 210, the prompt sections, and inference hyperparameters (e.g., in the repository) of generative artificial intelligence (AI) models. At block 1106, the prompt template and inference hyperparameters module 150 is configured to perform a search (e.g., search algorithm) including hyperparameter optimization over the search space (e.g., search space 212), where a loss metric is determined using the sample prompts and expected outputs for the sample prompts, where the search and the hyperparameter optimization determine a selected inference hyperparameters (e.g., values of the selected inference hyperparameters) of the generative AI models and a selected prompt template (e.g., a prompt template of the prompt templates 210) as combination based on the loss metric. At block 1108, the prompt template and inference hyperparameters module 150 is configured to cause a presentation (e.g., on a display screen, speakers, etc.) of the combination of the selected inference hyperparameters and the selected prompt template.

The (values of the) inference hyperparameters of the generative artificial intelligence AI models are configured to be modified and executed during runtime. The prompt sections comprise constraints (e.g., constraints in the order for the system prompt section 402, extractive schema linking section 404, content linking section 406, SQL generation section 408, generative schema linking section 410).

A set of the sample prompts and the expected outputs is used to create a validation set for metric calculation, and the search and the hyperparameter optimization are guided by the metric calculation of the loss metric. The prompt templates 210 are configured to be represented in a hierarchical structure (e.g., prompt sections that connected together in an order) that is flattened into the search space (e.g., search space 212). The loss metric can include rouge-L, cosine similarity, edit distance, and/or tree structure edit distance.

The prompt template and inference hyperparameters module 150 is configured to, in response to a user input of a user prompt, form a request 221 including text of the user prompt formatted in the selected prompt template and the selected inference hyperparameters, cause the request 221 to be input to at least one generative AI model in order to receive an output response 222, and present the output response 222 to the user.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
creating prompt templates using natural language questions and sample prompts, the prompt templates comprising prompt sections;
creating a search space comprising the prompt templates, the prompt sections, and inference hyperparameters of generative artificial intelligence (AI) models;
performing a search including hyperparameter optimization over the search space, wherein a loss metric is determined using the sample prompts and expected outputs for the sample prompts, wherein the search and the hyperparameter optimization determine selected inference hyperparameters of the generative AI models and a selected prompt template as combination based on the loss metric; and
causing a presentation of the combination of the selected inference hyperparameters and the selected prompt template.

2. The computer-implemented method of claim 1, wherein the inference hyperparameters of the generative AI models are configured to be modified and executed during runtime.

3. The computer-implemented method of claim 1, wherein the prompt sections comprise constraints.

4. The computer-implemented method of claim 1, wherein:
a set of the sample prompts and the expected outputs is used to create a validation set for metric calculation; and
the search and the hyperparameter optimization are guided by the metric calculation of the loss metric.

5. The computer-implemented method of claim 1, wherein the prompt templates are configured to be represented in a hierarchical structure that is flattened into the search space.

6. The computer-implemented method of claim 1, wherein the loss metric comprises rouge-L, cosine similarity, edit distance, or tree structure edit distance.

7. The computer-implemented method of claim 1, further comprising in response to a user input of a user prompt, forming a request comprising text of the user prompt formatted in the selected prompt template and the selected inference hyperparameters;
causing the request to be input to at least one generative AI model in order to receive an output response; and
presenting the output response.

8. A system comprising:
a memory comprising computer readable instructions; and
a processing device for executing the computer readable instructions, the computer readable instructions controlling the processing device to perform operations comprising:
creating prompt templates using natural language questions and sample prompts, the prompt templates comprising prompt sections;
creating a search space comprising the prompt templates, the prompt sections, and inference hyperparameters of generative artificial intelligence (AI) models;
performing a search including hyperparameter optimization over the search space, wherein a loss metric is determined using the sample prompts and expected outputs for the sample prompts, wherein the search and the hyperparameter optimization determine selected inference hyperparameters of the generative AI models and a selected prompt template as combination based on the loss metric; and
causing a presentation of the combination of the selected inference hyperparameters and the selected prompt template.

9. The system of claim 8, wherein the inference hyperparameters of the generative AI models are configured to be modified and executed during runtime.

10. The system of claim 8, wherein the prompt sections comprise constraints.

11. The system of claim 8, wherein:
a set of the sample prompts and the expected outputs is used to create a validation set for metric calculation; and
the search and the hyperparameter optimization are guided by the metric calculation of the loss metric.

12. The system of claim 8, wherein the prompt templates are configured to be represented in a hierarchical structure that is flattened into the search space.

13. The system of claim 8, wherein the loss metric comprises rouge-L, cosine similarity, edit distance, or tree structure edit distance.

14. The system of claim 8, wherein the processing device is controlled to perform the operations further comprising, in response to a user input of a user prompt, forming a request comprising text of the user prompt formatted in the selected prompt template and the selected inference hyperparameters;
causing the request to be input to at least one generative AI model in order to receive an output response; and
presenting the output response.

15. A computer program product comprising:
a set of one or more computer-readable storage media;
program instructions, collectively stored in the set of one or more storage media, for causing a processor set to perform computer operations:
creating prompt templates using natural language questions and sample prompts, the prompt templates comprising prompt sections;
creating a search space comprising the prompt templates, the prompt sections, and inference hyperparameters of generative artificial intelligence (AI) models;
performing a search including hyperparameter optimization over the search space, wherein a loss metric is determined using the sample prompts and expected outputs for the sample prompts, wherein the search and the hyperparameter optimization determine selected inference hyperparameters of the generative AI models and a selected prompt template as combination based on the loss metric; and
causing a presentation of the combination of the selected inference hyperparameters and the selected prompt template.

16. The computer program product of claim 15, wherein the inference hyperparameters of the generative AI models are configured to be modified and executed during runtime.

17. The computer program product of claim 15, wherein the prompt sections comprise constraints.

18. The computer program product of claim 15, wherein:
a set of the sample prompts and the expected outputs is used to create a validation set for metric calculation; and
the search and the hyperparameter optimization are guided by the metric calculation of the loss metric.

19. The computer program product of claim 15, wherein the prompt templates are configured to be represented in a hierarchical structure that is flattened into the search space.

20. The computer program product of claim 15, wherein the loss metric comprises rouge-L, cosine similarity, edit distance, or tree structure edit distance.
